(19) United States
(12) Patent Application Publication
(10) Pub. No.: US 2004/0059643 A1
(43) Pub. Date: Mar. 25, 2004

(54) Viewing previously run movies in theaters

(76) Inventor: David Marti, Salt Lake City, UT (US)

Correspondence Address: CARL T. REED, WORKMAN NYDEGGER, 1000 Eagle Gate Tower, 60 East South Temple, Salt Lake City, UT, 84111, US

(21) Appl. No.: 10/661,944

(22) Filed: Sep. 12, 2003

Related U.S. Application Data
(60) Provisional application No. 60/411,554, filed on Sep. 18, 2002.

(51) Int. Cl. G06F 17/60

(52) U.S. Cl. 705/26

(57) ABSTRACT

Systems and methods for viewing a previously run movie in a theater. Users request to view a movie at a website. The movie is associated with a location and/or a threshold. The threshold is related to users that commit to view the movie. At the website, users commit to view the movie by paying now or by paying when the threshold is satisfied. When the threshold of a movie is satisfied, the users that have committed to view the movie are notified that the movie will be shown at a particular location.

### CROSS-REFERENCE TO RELATED APPLICATIONS

The present invention claims the benefit of U.S. Provision Application No. 60/411,554, filed Sep. 18, 2002, which is incorporated by reference.

### BACKGROUND OF THE INVENTION

1. The Field of the Invention

The present invention relates to systems and methods for viewing movies. More particularly, the present invention relates to systems and methods for identifying interest to bring a movie back into a theater.

2. Background and Relevant Art

The experience of seeing a movie in a dark theater with other people who have also come to enjoy the movie has been a virtual cornerstone of the entertainment industry for decades. In spite of predictions that movie theatres will become a thing of the past with the advent of video cassette recorders (VCRs) and digital video disks (DVDs), the movie theater experience continues to be widely popular and each year, billions of dollars are spent by consumers to view movies in theaters. For many people, viewing a movie in a theater, with its large screen and enhanced sound, is an experience that is difficult to impossible on smaller systems.

Typically, a first run movie can be seen in theaters for several weeks. After a movie's first run in theaters, the movie is no longer available in theaters and consumers are usually limited to watching the movie on their televisions using video cassettes or digital video disks. Once a movie finishes its first run in theaters, the movie is unlikely to return to the big screen of a movie theater. Of course, there are some exceptions to this general rule—some movies such as cult classics like The Rocky Horror Picture Show and re-edited and/or re-mastered blockbusters like Star Wars, have been shown in theaters. Film festivals sometimes show movies in theaters. As a general rule however, most movies are not shown in theaters after their first run. In fact some movies are never seen in a theater but are released directly to video. If a person misses the opportunity to view a movie in a theater, that person is unlikely to have another opportunity to view the movie in a theater and must usually settle for viewing the movie on a significantly smaller screen.

Generally stated, movies are released into theaters with the goal of making a profit. Given the current and traditional structure of the movie market, it is difficult to re-release a movie into theaters for a second run as the ability to make a profit during a second run is less certain. Many movies are release directly to video, as previously stated, because they do not seem to have the potential of making enough profit in theaters. In other words, releasing a movie in theaters is an expensive process whose profitability is uncertain.

One of the reasons that profitability associated with re-releasing a movie in theaters is uncertain is that it is difficult to determine if there is sufficient demand for a particular movie. Releasing a movie to empty or nearly empty theaters is not profitable. Thus, the inability to determine or identify the demand for a particular movie and the cost involved in re-releasing a movie are risks that are too great for those that control whether the movie is re-released into theaters.

As a result, consumers that have an interest in seeing a movie in a theater are usually only able to see the movie in a theater during the first run of the movie in theaters. Consumers cannot call a theater and ask when a particular movie will be playing again because there is typically no plan, on the part of the movie theater, to show that movie again.

### SUMMARY OF THE INVENTION

These limitations and other problems are overcome by the present invention, which relates to systems and methods for viewing previously released movies in theaters. More particularly, the present invention relates to systems and methods that permit movies to be re-released to theater(s) for viewing. In one embodiment, profitability concerns and/or other concerns are alleviated by identifying an audience that has committed to purchase tickets and/or that have purchased tickets to view the movie. This can be achieved by associating each movie with a profit or attendance threshold.

In one embodiment, a website is provided that users can access. On the website, users can select a movie for viewing. Selecting a movie can be aided by allowing users to search for movies. Users are able to search for movies, for example, based on different categories such as title, genre, and the like. After the user selects a movie, the user submits a request to the website to view the selected movie. When enough users have requested the selected movie, the movie can be shown in a theater. Often the threshold associated with the movie determines when the movie can be shown in the theater. The threshold is an indication of whether the movie can be shown profitably.

Once a pre-determined threshold for the selected movie has been met, then the movie is sent to a particular theater and shown to those who indicated interest or have committed to view the movie. Commitment to view a movie include purchasing tickets in advance, promising to pay for a ticket when the threshold is met, and the like. After the threshold is met, the users that committed to view the movie are notified that the movie the threshold is met and that the movie will be shown in a theater. Others may also be notified in an effort to further boost attendance. The notification typically identifies the time, place, and date of the showing. The users that promised to pay are required to pay at this time.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment for implementing embodiments of the present invention;

FIG. 2 illustrates one embodiment of a method for viewing movies in a theater;

FIG. 3 illustrates another embodiment of a method for viewing movies in a theater; and

FIG. 4 illustrates one embodiment of a data structure used to monitor a threshold requirement that should be satisfied before a movie associated with the threshold is viewed in a theater.

### DETAILED DESCRIPTION OF THE PREFERRED EMBODIMENTS

When movies are produced and released to theaters in a first run, consumers are able to view the movie on a large screen and enjoy the video and audio technology of the theater environment. Many movies are created to take advantage of the video and audio hardware found in theaters, thereby enhancing the user movie viewing experience. As a result, seeing a movie in a theater is an experience that is different from viewing the same movie on a television set. As previously described, however, consumers have a limited amount of time to view a movie in a theater because after a movie finishes its first run, it is unlikely that the movie will return to theaters at a later date.

The present invention relates, in one embodiment, to systems and methods for viewing movies in theaters. Further, embodiments of the present invention relate to bringing movies that have already been shown in theaters back to theaters. The present invention is not limited to bringing first run movies back to a theater but also relates to bringing any audio and or video production to a particular location for a performance. As used herein, movie includes, but is not limited to, visual and/or audio/visual productions. The present invention may also relate to live theater and the like or other types of performances. Advantageously, embodiments of the present invention can identify the demand for a particular production or performance and commit users to purchase tickets. This helps ensure that a showing of a particular movie is, for example, profitable for the parties involved. The present invention is described in terms of movies, but one of skill in the art can appreciate that the present invention can be implemented with other types of performances.

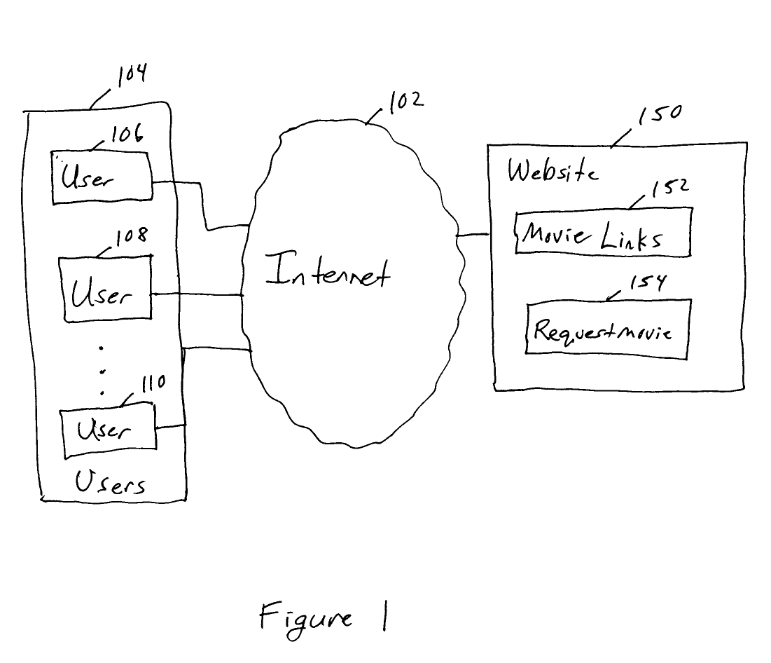

FIG. 1 illustrates an exemplary environment for implementing embodiments of the present invention. In this example, users 104 accesses a website 150 over a network such as the Internet 102. The users 104, in this example, are represented by the users 106, 108, and 110. Each user can be a person, a group of persons, an entity, an organization, and the like or any combination thereof.

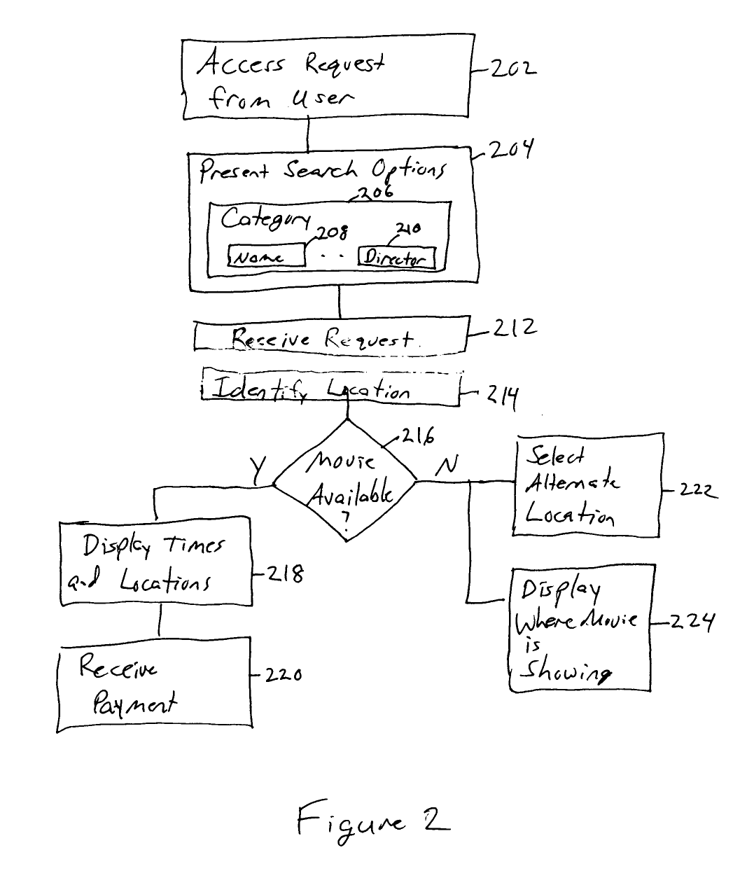

When users 104 visit the website 150, the website 150 enables the users 104 to select a movie that the users 104 would like to view in a theater. In this example, the website 150 helps the users 104 identify a movie by providing the users 104 with the ability to search for particular movies (or other performances) or for information about particular movies. The movie links 152, for example, may include a plurality of links that direct a particular user to other websites that provide information about particular movies. The movie links 152 may lead to reviews, trailers, photographs, and the like or any combination thereof. If the user 106 desires to view a particular movie in the theater, the user can request the particular movie through the request movie button 154 as described in more detail with respect to FIG. 2.

Generally stated, theater owners and/or others that have an interest in a particular movie will bring the movie back to the theaters if it is economically beneficial. In one embodiment, the present invention measures demand in a manner that permits a movie to be brought into a theater. The risks associated with unknown demand are reduced or eliminated. If a certain amount of profit or attendance, for example, is required before a movie is brought back, embodiments of the present invention ensure that the requisite profit and/or attendance requirement is satisfied.

Advantageously, theater owners or movie owners bear little risk because the movie is not shipped unless the thresholds are satisfied. In one embodiment, for example, profit and/or attendance thresholds are predetermined. These thresholds can be determined and/or satisfied using the website 150. Once the thresholds have been reached for any given movie, then the movie can be delivered to the theater and shown to a pre-sold audience. If the profit or attendance threshold is not reached for any given movie in a region, city or locality, then the movie is not shipped and the consumers that did express interest are not charged admission. In other words, the website 150 can be used to identify or measure the interest and demand for a particular movie before any financial commitment is required.

The website 150 is accessible to users according to various factors such as specific movie titles, directors, actors, genre, geography, time period, and the like or any combination thereof. The website 150 has movie links 152, as previously described, to and from one or more of the major and minor websites that relate to movies. The website 150 may maintain or have access to one, many, or all movies and provide a way for consumers to “vote” on which movies they would pay to see again in a theater. If that movie is already scheduled to show in their area, then the users 104 are able to buy a ticket immediately. If the profit or attendance threshold has not yet been reached for a movie in their area but has been reached in another area, the user may be given the opportunity to purchase a ticket for that area. And if the movie is not yet scheduled to shown in any area, or if the consumer prefers to wait until it is shown in his or her area, the consumer may leave their name and/or email address or other contact information. The consumer will then be notified when the relevant threshold is reached. Embodiments of the present invention can also be implemented over a telephone system where people call in to let their desire to view a movie be made known as opposed to logging in to a web site for a similar purpose.

The website 150 can be used to sell tickets or to gauge interest or demand for more than movies. The website 150 can be used to identify demand or interest in a movie and its sequel (or prequel), for movies of a particular director or actor, or for movies in a particular genre. Embodiments of the present invention enable consumers to schedule a particular movie for a particular group in a theater.

In addition to movies, a music/video artist could sell tickets to see their best music videos, or even live concerts on film or video. Independent film makers could pre-sell tickets to their next-and-yet-to-film movie project to those who love their work and/or wish to support independent films. Speeches such as the famous Martin Luther King speech, other historical films or newsreels can also be viewed in a theater using embodiments of the present invention as features by themselves or along with a particular movie, etc.

FIG. 2 illustrates one embodiment of a method for viewing movies in theaters. Typically, an access request is received (202) from a user to a website such as the website discussed with reference to FIG. 1. Users log on to the website directly or from a link from another site. In one embodiment, users are initially required to provide their location (such as by zip code) because each movie can be associated with different locations.

The user is next presented with various search options (204). The user, for example, can search for a movie by category 206, name/title 208, or by director 210. Other categories may include, but are not limited to, by director, by genre, by release date, by country of origin, and the like or any combination thereof. One of skill in the art can appreciate that other search options may be presented. Presenting search options is one way a user can identify or select a movie that the user would like to view in a theater.

After a user selects a category (and any further sub-categories), the user is provided a list of movies in that category. The website may also display an indicator that tells the user how much interest already exists in a particular movie or how many people have already committed to purchase a ticket, and the like. This may help the user know whether the threshold for a particular movie in a particular location is met or is close to being satisfied. The indicator is typically created using the user's home location. Thus, each movie may be associated with multiple indicators. The indicator displayed to a particular user is based on the location of that user.

After a movie is identified, the website receives a request (212) for that movie from the user. The website should also identify a location (214) of the user as previously mentioned. Identifying the location of a user can occur at any time. The website, for example, may require users to initially register with the site such that the user's location is already known. After the location is known or after the user has selected a particular movie, the website can determine if the movie is available (216) for viewing in a theater in the same location as the user.

If the movie is available or already scheduled to be shown, the website displays the locations (218) where the movie is showing. Each location typically includes a date, time, and place. The user can next purchase a ticket for one of the shows (220). If the movie is not currently available in a location of the user, then the website may provide alternate locations (222) to the user. These alternate locations may require the user to travel. However, the user is not required to purchase a ticket. Alternatively, the website displays where the selected movie is currently showing (224). The user can then decide if a ticket purchase is warranted in view of where the movie is playing.

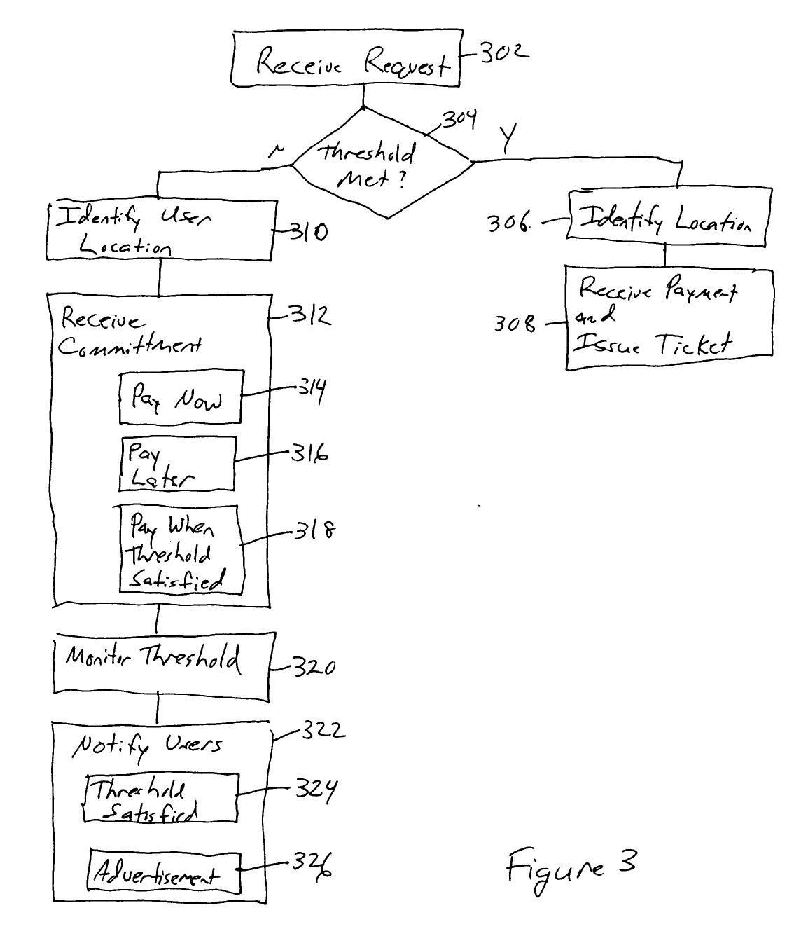

In FIG. 2, the movie is available in some location. FIG. 3 illustrates one embodiment where the movie is not available for viewing in a theater. The embodiment illustrated in FIG. 3 utilizes a threshold to determine when a movie becomes available for viewing. After a user has identified a movie as described above for example, a request is received (302) from the user to view the movie in a theater or other suitable location. Next, a threshold determination is performed (304) for the selected movie. The threshold can be an attendance threshold that is based, for example, on the number of users that have already paid to see the movie, that have committed to pay for the movie, and the like. Alternatively, the threshold can be a profit threshold or revenue threshold that is based on how much money is being made. Typically, the revenue threshold can be expressed as an attendance threshold and vice versa. However, embodiments of the present invention permit the price paid by users to vary. Thus, a profit threshold may change the number of users needed to reach the profit threshold. In one embodiment, the threshold is updated after each user request is processed. Thus, the determination of whether the threshold is met is based on the actions of prior users. However, the threshold can also be met based on the current request.

If the threshold is satisfied, then the locations where the movie is showing are presented to the user (306). The location (including date, place, and time) can be ordered based on the user's own location. The user can select one of the showings and payment is received (308). Next, a ticket may be issued to the user electronically in this example.

If the threshold is not met, then the user is presented with potential locations (310). As previously stated, a location may include the date, time and place. This gives the user the ability to select a specific location in addition to the movie. Alternatively, the location is not provided until the threshold is met. Preferably, however, the potential locations are all related to a location of the user. Thus, the potential locations from which a user may select are all relatively close to the user. This is one of the reasons that more than one threshold is associated with each movie. In other words, it is not helpful to display a location that the user that is not within a close traveling distance. In one embodiment, each movie is associated with a particular location (such as a city or a group of zip codes). The particular location is associated with a threshold.

Next, a commitment is received from the user (312). The commitment can be received in different manners. For example, a user can pay now (314) even though the threshold has not been met. The user can request a refund at a later date, a refund may be automatically applied if the threshold is not met within a particular time period, and the like. Alternatively, the user can pay later (316). In this case, the user is required to pay once the threshold is met, but the user is required to give permission at a later time. In yet another case, the user can authorize a transaction to occur when the threshold is satisfied. The user provides a credit card, for example, that is charged when the threshold is satisfied and further authorization or permission from the user is not required.

In some embodiments, it may be necessary to insure that payment will be received for the movie or that a certain monetary or profit threshold will be met. This can be accomplished, for example, by having users provide a credit card number that will only be charged when one of the predetermined levels has been reached. The user thus gives permission for their card to be charged in this instance. Thus user will likely be notified that the threshold has been reached and all of the users that indicated interest will be notified of the date when the movie will be shown. If the interest or other threshold level is not reached, then the credit cards will not be charged.

After the commitment is received from the user, the threshold is monitored (320) and adjusted as other users request movies. When the threshold is satisfied, the users are notified that the movie is scheduled for viewing. In this embodiment, users are notified view email (324) that the threshold is met. The users are also given a location (including date and time). Users that promised to pay later are usually required to pay at this time. In one embodiment, the threshold reverts to being unsatisfied is users that promised to pay do not pay. In this case, a notification is first sent to these users asking them to pay before a notification is sent to all users indicating that the threshold has been satisfied.

A notification can also occur even if the threshold is not met. For example, an electronic advertisement (326) can be used to solicit ticket purchases that help meet the threshold. In another embodiment, a notification can be sent to users that have already committed to pay to view the movie. The notification may indicate how many more users are needed to meet the threshold. This may encourage these users to ask their friends, etc., to access the website (or call) and commit to view the movie. Users, for example, can provide an email address that can be used to notify the user when the movie is showing in their location or other chosen location. In another embodiment, a user can be notified when the threshold is almost satisfied, in which case the user may be willing to pay more (thus reaching the threshold) or will be able to ask friends to commit to view the movie. A user may be able to pay a premium, thereby indicating a high level of interest and making it easier to meet the threshold.

In some instances, it may be necessary to insure that payment will be received for the movie or that a certain monetary threshold will be met. This can be accomplished, for example, by having users provide a credit card number that will only be charged when one of the predetermined levels has been reached. The user thus gives permission for their card to be charged in this instance. Thus user will likely be notified that the threshold has been reached and all of the users that indicated interest will be notified of the date when the movie will be shown. If the interest or other threshold level is not reached, then the credit cards will not be charged.

In another embodiment, a notification may be sent to various users informing them that a particular movie will be shown in a particular location. This advertisement can also be made, for example, in local media. This may enhance revenue by notifying users that have not expressed interest in a certain movie that that movie is playing. There may also be an option to notify users of events or offers available, i.e., if another movie of a particular genre or director, but not their chosen movie becomes available in their area. In general notifications can be used to generate interest in movies. In one embodiment, the movie will be open to the public and people are welcome to attend even if they do not have prior notice. In this manner, the users are able to provide definite information to movie distributors about which movies they want to see.

Once the interest level or threshold for a particular movie, which may be predetermined, has been reached, it is financially viable for the movie to be shown in that theater. This may indicate, that a particular movie is only shown in a single theater instead of a wide release to many different theaters.

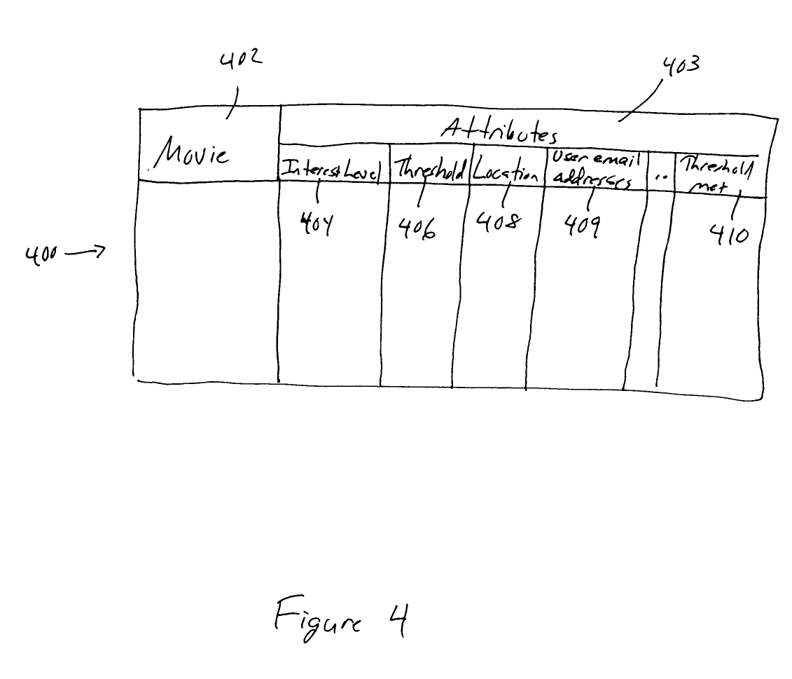

FIG. 4 illustrates one embodiment of a database used by a website to enable a movie to be shown in a particular location. The database 100 includes a movie field 402. Each entry in the movie field 402 is associated with attributes 403. The attributes 403 illustrated in the database 400 are exemplary attributes. Thus, other attributes can be added as needed or removed if desired.

In this example, the interest level attribute 404 represents the number of users that have committed to view the associated movie. The threshold attribute 406 identifies the threshold that needs to be met before the movie is released. The threshold attribute 406 may identify, for example, the number of users that need to select the pay now option or the attribute 406 may identify the number of users that need to select the pay when threshold met option before the movie is released to a particular location. Often, the interest level attribute 404 is used to determine if the threshold in the threshold attribute 406 has been satisfied.

The location attribute 408 may identify a particular place, date, and time that a particular movie will be shown when the threshold is met or is currently being shown. The location attribute 408 may also include more than one location. Alternatively, the same movie may exist in the database 400 more than once. The user email address attribute 409 contains a pointer to a list of email addresses in this example. The list may include, for example, users that have committed to buy a ticket and view the movie in a theater. The email address attribute is used for notification purposes as described previously. In addition, the email addresses that receive a notification for a particular movie is not necessarily limited to the email addresses associated with the email address attribute 409. The threshold met attribute 410 identifies whether the threshold has been satisfied. As previously described, notifications are generated when the threshold is satisfied. Notifications can also be generated when the threshold is nearly satisfied.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for viewing a movie in a theater, the method comprising:
receiving a request from one or more users to view a movie in a theater in a particular location, wherein the movie is associated with a threshold;
receiving a commitment to purchase a ticket to the movie from the one or more users if the threshold is not satisfied;
determining whether a threshold for the movie is satisfied; and
notifying the one or more users when the threshold is satisfied and that the movie can be viewed in the theater by the one or more users.

2. A method as defined in claim 1, wherein receiving a request from one or more users to view a movie in a theater in a particular location further comprises:
logging the one or more users into a website;
searching for the movie; and
identifying a location for each of the one or more users.

3. A method as defined in claim 1, wherein receiving a commitment to purchase a ticket to the movie further comprises one or more of:
receiving payment from the one or more users; and
receiving payment from the one or more users when the threshold is satisfied.

4. A method as defined in claim 3, wherein receiving payment from the one or more users further comprises refunding payment to the one or more users if the threshold is not satisfied or if the threshold is not satisfied in a particular time period.

5. A method as defined in claim 1, wherein determining whether a threshold for the movie is satisfied further comprises at least one of:
determining if a profit threshold for the movie is satisfied based on the commitment of the one or more users; and
determining if an attendance threshold for the movie is satisfied based on the commitment of the one or more users.

6. A method as defined in claim 1, wherein notifying the one or more users when the threshold is satisfied further comprises identifying a location to the one or more users where the movie will be shown, wherein the location includes a place, a time, and a date.

7. A method as defined in claim 1, wherein determining whether a threshold for the movie is satisfied further comprises monitoring the threshold as additional requests are received.

8. A method as defined in claim 1, further comprising, notifying the one or more users that the threshold can be satisfied if at least one of the one or more users pays a premium for the movie.

9. A method as defined in claim 1, wherein the movie is one of:
a movie that was previously released in theaters;
a movie that was never released in theaters;
a historical documentary;
a movie that is in a production or planning stage; and
a visual/audio performance.

10. A method as defined in claim 1, wherein notifying the one or more users when the threshold is satisfied further comprises showing the movie at a location of the one or more users, wherein the location is associated with the one or more users and with the movie.

11. A computer-readable medium having computer executable instructions for performing the method of claim 1.

12. In a system including a movie that has been shown previously in a theater and is not currently scheduled to be shown the theater again, a method for showing the movie in the theater, the method comprising:
receiving input at a website from one or more users of the website, wherein the input represents a movie that the one or more users desire to see in a theater;
maintaining interest level data at the website in response to the input from the one or more users, wherein the interest level data represents a commitment of the one or more users to view the movie in the theater;
comparing the interest level data against a pre-determined threshold; and
releasing the movie for viewing in the theater when the interest level data surpasses the pre-determined threshold.

13. A method as defined in claim 12, wherein receiving input further comprises receiving input over a telephone system.

14. A method as defined in claim 12, further comprising displaying the interest level data on the website.

15. A method as defined in claim 12, further comprising committing some of the one or more users to view the particular movie.

16. A method as defined in claim 12, further comprising receiving a commitment from some of the one or more users, wherein the commitment is not collected until the interest level data has surpassed the pre-determined threshold.

17. A method as defined in claim 12, wherein the interest level data further comprises one or more indicators, wherein each indicator corresponds to a different location, further comprising displaying a particular indicator to a particular user, wherein a location associated with the particular indicator is also associated with a particular user.

18. A computer-readable medium having computer executable instructions for performing the method of claim 12.

19. In a system including a movie that has previously been shown in a theaters, a method for causing the movie to be shown in a particular theater again, the method comprising:
determining a commitment of one or more users to view the movie in the particular theater, wherein the commitment increases each time a new user commits to view the movie;
when the commitment passes a threshold, notifying the one or more users that have committed to view the movie that the threshold has been satisfied and that the movie will be shown in the particular theater; and
showing the movie in the particular theater to at least the one or more users that have committed to view the movie.

20. A method as defined in claim 19, wherein determining a commitment of one or more users to view the movie in the particular theater further comprises:
receiving payment from some of the one or more users before the threshold is satisfied; and
receiving payment from some of the one or more users after the threshold has been satisfied.

21. A method as defined in claim 21, wherein receiving payment from some of the one or more users after the threshold has been satisfied further comprises receiving payment before notifying the one or more users that the threshold has been satisfied.

22. A method as defined in claim 19, further comprising notifying other users that the movie will be shown in the particular theater.

23. A method as defined in claim 19, further comprising asking some of the one or more users to pay a premium such that the threshold is satisfied with fewer users.

24. A method as defined in claim 19, wherein determining a commitment of one or more users to view the movie in the particular theater further comprises receiving a request from a particular user for the particular movie.

25. A method as defined in claim 24, wherein determining a commitment of one or more users to view the movie in the particular theater further comprises searching for the particular movie.

26. A method as defined in claim 19, further comprising linking to or from other websites that provide information related to the particular movie.
